(19) United States
(12) Patent Application Publication
(10) Pub. No.: US 2012/0308978 A1
(43) Pub. Date: Dec. 6, 2012

(54) APPARATUS AND SYSTEM FOR LEARNING

(76) Inventor: George Pert, Heathcote (AU)

(21) Appl. No.: 13/577,424

(22) PCT Filed: Dec. 23, 2010
(86) PCT No.: PCT/AU10/01734

§ 371 Date: Aug. 6, 2012

(30) Foreign Application Priority Data
Feb. 5, 2010 (AU) 2010900475

(51) Int. Cl. G09B 19/12

(52) U.S. Cl. 434/304

(57) ABSTRACT

The invention comprises an apparatus for learning as illustrated in FIG. 1. The apparatus for learning comprises a means having a primary display function with a periodic change and a secondary means for displaying a range of learning elements, wherein one or more of the range of learning elements are displayed at any one time and are periodically changed in accordance with the periodic change of the primary means.

### FIELD OF THE INVENTION

This invention relates to an apparatus and means for learning and in particular to an apparatus and means for learning arithmetic or other mathematical or scientific elements.

Whilst the invention can be applied to learning a range of disciplines for convenience sake it shall be described herein in terms of an apparatus and means for learning arithmetic.

### BACKGROUND TO THE INVENTION

It is long considered that rote learning or repetitive learning is not an exciting form of learning for students during the initial years of primary school. Therefore the more difficult aspects of arithmetic are often not mastered sufficiently to provide a basis for more complex mathematics in later years.

Similar problems apply for secondary students who need to master aspects of repetitive learning for other subjects such as the Presidents of America for history, the chemical elements for chemistry, the sharps and flats in major and minor scales in music, a range of writing symbols and their meanings in pictorial languages such as Chinese or Japanese etc.

Accordingly, it is an object of the present invention to overcome or substantially ameliorate the disadvantages of the prior art by providing an apparatus or system of learning that assists repetitive learning.

### SUMMARY OF THE INVENTION

In accordance with the invention there is provided an apparatus and means for learning comprising:
a means having a primary function with a periodic change;
and a secondary means for displaying a range of learning elements;
   wherein one or more of the range of learning elements are displayed at any one time and are periodically changed in accordance with the periodic change of the primary means.

The means having a primary function with a periodic change can be a time piece.

The periodic change is preferably dependent on the time of day rather than the time between events.

The means having a primary function with a periodic change can be other than a time piece but which has a change of form based on time or event. This can include a signal indicating a patient is in attendance at a hospital or doctor's surgery and provides an educational tool for patients. This is particularly beneficial in paediatric locations but could also be in use in learning difficulty patients.

More preferably the display of a range of learning elements on the secondary means is directly related to the display of the means having a primary function with a periodic change. In this way relationships are developed which increase the retentiveness of the knowledge by the viewer.

In one form of the present invention there is provided an apparatus and means for learning comprising:
a) an analogue clock face with numbers 1-12 and two hands for show minutes and hours;
b) a display located on the clock face for showing an arithmetic equation;
c) the numbers displayed in the arithmetic equation are determined by the position of the hands;
   whereby the time is related to a different arithmetic equation and answer.

In one example at 2:45 the equation can be 2×9.

In another form of the present invention there is provided an apparatus and means for learning comprising:
a) a digital clock face with two groups of numbers to show minutes and hours;
b) a display located on the clock face for showing an arithmetic equation;
c) the numbers displayed in the arithmetic equation are determined by the numbers showing minutes and hours;
   whereby the time is related to a different arithmetic equation and answer.

The analogue or digital clock face can be displayed on a computer screen with a related arithmetic equation located substantially adjacent or at least in a related position.

In one example at 2:45 the equation can be 2×(4+5)=18; at 2.47 the equation could be 2×(4+7)=22; etc.

It can be seen that the invention provides a means of providing a randomised arithmetic problem based on the position of clock hands corresponding to a time of day.

The apparatus and means for learning can comprise a first physical means for performing the primary function with a periodic change and can include a replaceable module for providing secondary means for displaying a range of learning elements. In this way different ranges of learning elements can be inserted and operated dependent on different audience, different subject or just to effect a change.

The apparatus can be a known means such as and the secondary means can alter its operation or its display to provide the system of learning instead of or in combination with the normal operation of the apparatus.

In another form the apparatus and means for learning can comprise a multiple of selectable ranges of learning elements. In this way different ranges of learning elements can be selected and operated dependent on different audience, different subject or just to effect a change.

Also in accordance with the invention there is provided a system of learning arithmetic including the steps of:
(i) providing a periodically changing time element;
(ii) automatically selecting and displaying of one or more of a range of learning elements associated with arithmetic which are displayed at any one time according to the time of the periodically changing time element;
(iii) periodically changing the selecting and displaying of one or more of a range of learning elements in accordance with the periodic change of the primary means;
wherein the viewer can view the selecting and displaying of one-or more of a range of learning elements in accordance with the, periodic change of the primary means and learn the selecting and displaying of one or more of a range of learning elements in accordance with the periodic change of the primary means including with the use of repetitive showing over time and/or with the association of the selecting and displaying of one or more of a range of learning elements in accordance with the periodic change of the primary means.

In one form the apparatus for learning is in the virtual form as a virtual apparatus with learning elements comprising:
a means having a primary function with periodic change;
and a secondary means for displaying a range of learning elements, wherein one or more of the range of learning elements are displayed at any one time and are periodically changed in accordance with the periodic change of the primary means.

In accordance with the invention, there is provided a method of using a virtual apparatus for learning comprising:
(i) installing the virtual apparatus onto a computer;
(ii) recognition of the virtual apparatus according to a. controller providing predetermined features of the computer and the clock time;
(iii) determination by the controller of the essential elements of the clock time
(iv) displaying the essential elements of the clock time onto on the primary display function of the virtual apparatus; and
(v) displaying the question on the secondary display function on the virtual apparatus to provide a system of learning.

The method of using the can be used where the question to be displayed on the secondary display function is either related to the essential elements of the clock time displayed or displayed in. random.

The invention further provides a method of installing a virtual apparatus for learning comprising;
(i) uploading the virtual apparatus having a primary display function and secondary display function onto a computer
(ii) recognition of the virtual apparatus by a controller of a computer
(iii) determination by the controller of the essential features of the time clock and the virtual apparatus;
(iv) correlating the virtual apparatus to the time clock;
(v) identifying a question to be answered; and
(vi) displaying the virtual apparatus to provide a system of learning wherein the essential features of the time clock are displayed on the primary display function and the question to be answered is displayed on the secondary display function.

Further, the invention provides a method of using a virtual apparatus for learning comprising the steps of:
(i) obtaining a clock time
(ii) determining the essential elements of the time on the clock time;
(iii) displaying the essential features of the clock time on a virtual apparatus;
(iv) obtaining at least one question related to determined essential element;
(v) displaying related question and answer; and
(vi) Outputting a dual display of time and related question and answer.

The invention further comprises a method of using a virtual apparatus having a connection to a clock included in a predefined apparatus for learning comprising the steps of:
(i) determination of the essential features of a clock time, the essential features of the clock time being directed and read by a controller;
(ii) correlating the essential features of the clock time to the virtual apparatus;
(iii) displaying the essential features of the clock time on the virtual apparatus;
(iv) displaying a range of learning elements periodically, the frequency determined by the clock time on the virtual apparatus.

### BRIEF DESCRIPTION OF THE DRAWINGS

In order that the invention can be more readily understood an embodiment will be described by way of non-limiting example only with reference to the drawings wherein:

FIG. 1 provides a representation of an analogue clock face in accordance with an embodiment of the invention;

FIG. 2 presents diagrammatic views of a clock in accordance with the embodiment of the invention presented in FIG. 1 in multiple periodic changes of time being for each of the hours of 1.00 to 12.00 and in five minute intervals so as to correspond with the 1 to 12 times tables in accordance with one embodiment of the invention.

FIG. 3 provides a diagrammatic illustration of a digital clock face in accordance with another embodiment of the invention;

FIG. 4 provides a diagrammatic illustration of a digital clock face in accordance with another embodiment of the invention;

FIG. 5 provides a diagrammatic illustration of a digital clock face in accordance with another embodiment of the invention;

FIG. 6 provides a diagrammatic illustration of a digital clock face in accordance with another embodiment of the invention;

FIG. 7 provides a diagrammatic illustration of a digital clock face in accordance with another embodiment of the invention;

FIG. 8 provides a diagrammatic illustration of a digital clock face in accordance with a further embodiment of the invention in virtual form;

FIG. 9 provides a diagrammatic flow chart illustrating the relationship between the computer and the virtual apparatus;

FIG. 10 provides a diagrammatic flow chart illustrating the relationship between the clock time of the computer and the virtual clock time;

FIG. 11 provides a diagrammatic flow chart illustrating the operation of the, virtual apparatus;

FIG. 12 provides a diagrammatic flow chart illustrating the operational features of the invention in the virtual embodiment; and,

FIG. 13 provides a diagrammatic illustration of a memory card in accordance with one embodiment of the invention.

### DESCRIPTION OF A PREFERRED EMBODIMENT OF THE INVENTION

The invention provides apparatus and means for learning. In the preferred embodiment, there is provided an apparatus and means for learning comprising of a primary function with, a periodic change and a secondary means of displaying a range of learning elements.

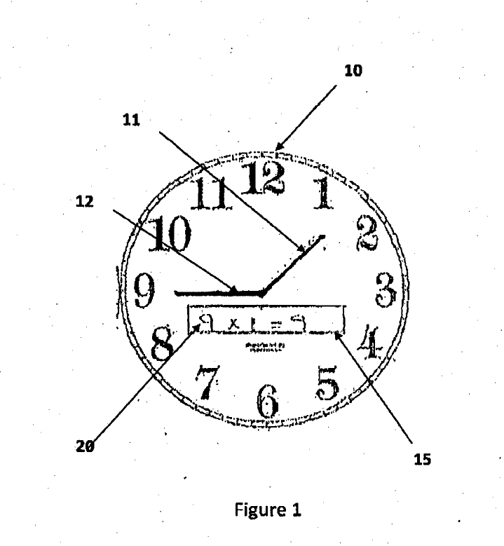

The preferred embodiment of the invention is, as represented in FIG. 1, whereby the apparatus is in the form of an analogue clock face 10 with numbers 1-12 and two hands 11, 12 for showing minutes and hours of the time. The clock further includes a secondary display 15 located on the clock face 10 for showing an arithmetic equation 20 or at least one learning element 20. The numbers displayed in the arithmetic equation are determined by the position of the hands 11,12 wherein each time is related to a different arithmetic equation and answer.

The primary function is that the equation is shown regularly at a particular time and changes periodically as the analogue clock face changes illustrating the time of day to the user. The clock face 10 is a primary display and includes a secondary display used to indicate to the user the arithmetic equation which must be solved. The equation is determined by the position of the hands of the clock used to present the time to the user.

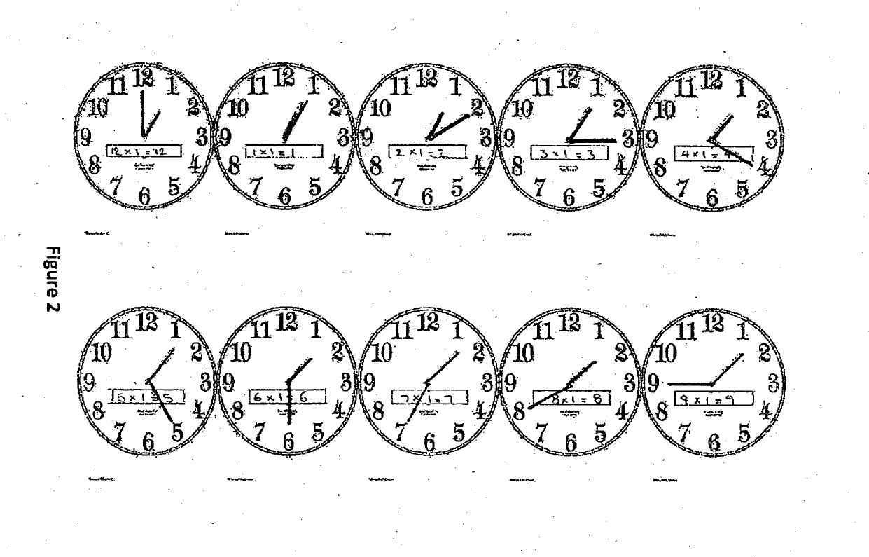

As shown in FIG. 2 in this form the following can occur:

| Time | Minute hand | Hour hand | equation | Answer |
|---|---|---|---|---|
| 9.05 | 5 facing No. 1 | facing No. 9 | 1 × 9 | 9 |
| 9.10 | 10 facing No. 2 | facing No. 9 | 2 × 9 | 18 |
| 9.15 | 15 facing No. 3 | facing No. 9 | 3 × 9 | 27 |
| 9.20 | 20 facing No. 4 | facing No. 9 | 4 × 9 | 36 |
| 9.25 | 25 facing No. 5 | facing No. 9 | 5 × 9 | 45 |
| 9.30 | 30 facing No. 6 | facing No. 9 | 6 × 9 | 54 |
| 9.35 | 35 facing No. 7 | facing No. 9 | 7 × 9 | 63 |
| 9.40 | 40 facing No. 8 | facing No. 9 | 8 × 9 | 72 |
| 9.45 | 45 facing No. 9 | facing No. 9 | 9 × 9 | 81 |
| 9.50 | 50 facing No. 10 | facing No. 9 | 10 × 9 | 90 |
| 9.55 | 55 facing No. 11 | facing No. 9 | 11 × 9 | 99 |
| 10.00 | 00 facing No. 12 | leaving No. 9 | 12 × 9 | 108 |

This is similarly repeated for each of the other hours as follows:

| | |
|---|---|
| 1.00 to 2.00 in 5 minute intervals | 1 × 1 = 1 to 1 × 12 = 12 |
| 2.00 to 3.00 in 5 minute intervals | 2 × 1 = 2 to 2 × 12 = 24 |
| 3.00 to 4.00 in 5 minute intervals | 3 × 1 = 3 to 3 × 12 = 36 |
| 4.00 to 5.00 in 5 minute intervals | 4 × 1 = 4 to 4 × 12 = 48 |
| 5.00 to 6.00 in 5 minute intervals | 5 × 1 = 5 to 5 × 12 = 60 |
| 6.00 to 7.00 in 5 minute intervals | 6 × 1 = 6 to 6 × 12 = 72 |
| 7.00 to 8.00 in 5 minute intervals | 7 × 1 = 7 to 7 × 12 = 84 |
| 8.00 to 9.00 in 5 minute intervals | 8 × 1 = 8 to 8 × 12 = 96 |
| 9.00 to 10.00 in 5 minute intervals | 9 × 1 = 9 to 9 × 12 = 108 |
| 10.00 to 11.00 in 5 minute intervals | 10 × 1 = 10 to 10 × 12 = 120 |
| 11.00 to 12.00 in 5 minute intervals | 11 × 1 = 11 to 11 × 12 = 132 |
| 12.00 to 1.00 in 5 minute intervals | 12 × 1 = 12 to 12 × 12 = 144 |

However, further embodiments using the basic method defined above with the intention of teaming can be accomplished.

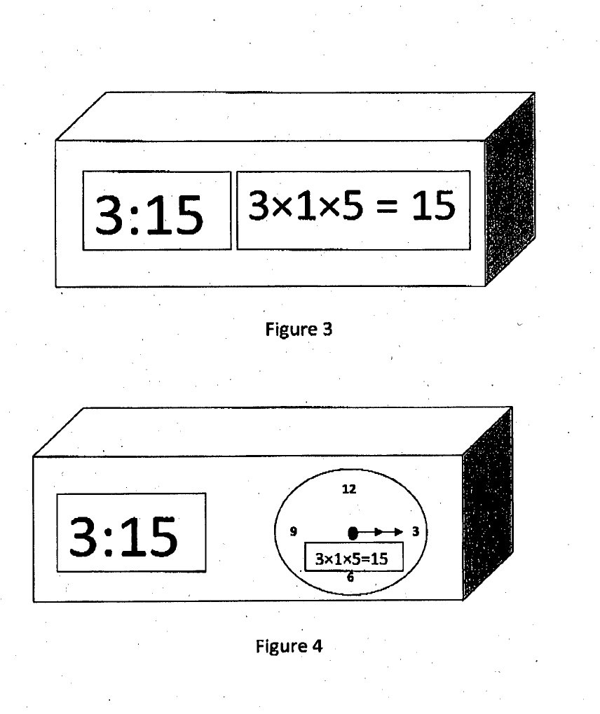

Further embodiments of the invention can include a digital clock incorporating the time, the equation and the answer. For example at 3:15, the subsequent mathematical equation that will need to be solved is 3×1×5 to which the answer 15 will be displayed. Such an embodiment is presented in FIG. 3.

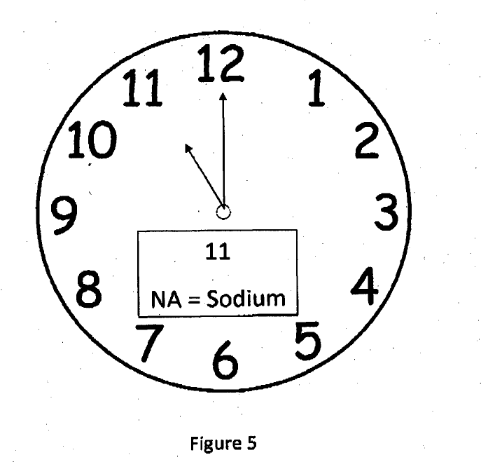

To allow for more difficult mathematical problems the display can randomly select an equation to present at a particular time. The secondary function can display a variety of equations to solve, including addition, subtraction, multiplication, division, or a combination of these. In addition, the equations can include decimals, fractions, numbers, roman numerals etc. Further to this embodiment in digital form, the display can itself include the time in digital form together with a pictorial demonstration of an analogous cloak illustrating the time and the equation that is to be displayed as illustrated in FIG. 4. Such an embodiment will not only assist in the learning of the arithmetic equation but will also assist in the learning and reading of time on an analogous display.

The digital form can extend beyond the preferred embodiment that uses a time piece as the primary function. This can include a display when the user is waiting in line for a service and is required to take a number. For example, the invention can present to the user that ticket holder number 12 is currently being attended to, to which it will further display 1×12=12.

Further embodiments can allow the mathematical equations to be replaced by Japanese characters. The digital display will then present the character and a pictorial illustration of its meaning, to which the user will need to identify. The invention can also aid users to learn to count to twelve in Japanese. In this way, at every hour, the digital display can illustrate the relevant words in Japanese to aid the user in learning to count to 12 in Japanese. For example, at 2 o'clock, the digital display will present ‘nl’ (meaning 2 in Japanese).

The invention can aid users in testing their memory in recalling the chemical elements in the periodic table. The secondary means of display can randomly present to the user the abbreviation of each chemical element to which the user will be required to determine the name of the element. For example, at 2 o'clock the element randomly displayed may be Ag, representing silver. Alternatively, the digital element of the invention can display ‘C’ at 6 o'clock to which the user Will need to recognise that the 6^{th} element in the periodic table is carbon thereby teaching the student the first 12 elements of the periodic table.

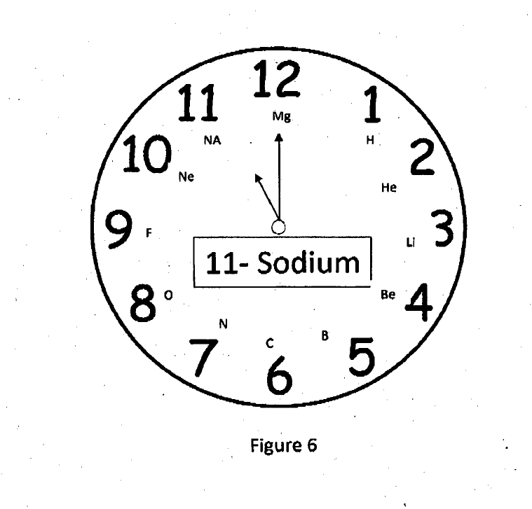

This embodiment can be presented in two forms as illustrated in FIGS. 5 and 6. In FIG. 5, the direction of the hour hand 12 is the element in the periodic table which must be guessed by the student. In the embodiment presented in FIG. 6, the symbols of each element is presented on the clock face 10 such that the user can recognise the symbol representing the element in addition to learning the first 12 elements.

More advanced users will benefit from a further level of difficulty where the clock will identify the group and period number as indicated b the hands of the clock to which the user will need to pinpoint the element. For example, at 1:10 pm, the student will need to recall Group 1A, Period 2=Li (lithium).

The secondary means of display can illustrate the days of the month, according to the relevant hour, in several languages. For example, in French Janvier can be portrayed in the digital screen at 1 o'clock as the first month of the year.

The secondary means of display can further illustrate the numerical value shown on the face of the clock as Roman numerals. For example, at 6 o'clock the digital display will present VI indicating to the user the equivalent value of 6 in Roman numerals.

In America a useful embodiment will be one in which the user can learn the names and placement of the American Presidents in US history. For example, the digital display can present to the user 26 TR. Which will require the user to determine who the 26^{th} president of America was using the initials as a hint. Alternatively, the user can be asked the name of the President after being shown the numerical position of the American President which is determined by the position of the hands of the clock. For example at 3 o'clock, the 3^{rd} American President that the user is required to recall is Thomas Jefferson.

Alternatively, the change in time can provide for different farm animal noise to which the farm animal is displayed accordingly in the display 15.

Further embodiments can allow the digital display to present more than words or numerical values but include pictures and sounds. This, in particular, can aid younger users to learn, for example, the English alphabet.

The digital screen can randomly display letters of the alphabet followed by a picture beginning with that letter. For example, it can display an ‘F’ followed by a pictorial illustration of a fish. Pictorial illustrations can also be used if younger users are to learn addition or subtraction. For example, at 1:10 pm the digital display of the secondary function can illustrate one apple+two apples=three apples. This will aid the user to independently determine and calculate the answer to the presented equation.

The secondary digital display can also aid the user in learning to read the time. For example, at 3:30 on the analogous clock the digital display can present to the user ‘Half past three.’

Further, the apparatus for learning can be modified to display questions to the user in relation to such topics as geography or history. Therefore, for example, at 3:30 pm the analogous clock face includes, how many states and territories does Australia have?

Further to such an embodiment, the apparatus for learning can require interaction with the user. Therefore, after providing a question the user may be able to enter an answer. If an answer is not entered or is entered incorrectly within a 5 minute span an alarm can sound. Alternatively, incorrect answers could be tracked by an internal microprocessor which allows for the recording of statistical information or listing of the questions answered incorrectly which, through a feedback loop, can be presented more frequently to the user.

The embodiments described above and shown in the figures are examples and are not intended to limit the invention to the precise forms disclosed. The invention can be manipulated to different sizes, different primary and secondary functions allowing for the display of a range of learning elements in a repetitive state to allow users to be constantly tested in a manner requiring them to continually recollect the required information.

For example an alternative embodiment includes the alteration of the position of the secondary means of displaying the learning elements. In comparison to FIG. 1, the secondary function can be presented on the face of the clock. Alternatively, it can be positioned permanently above or below the clock or move around the dock as the hands of the clock turn. Further, the face of the clock can be modified so that any

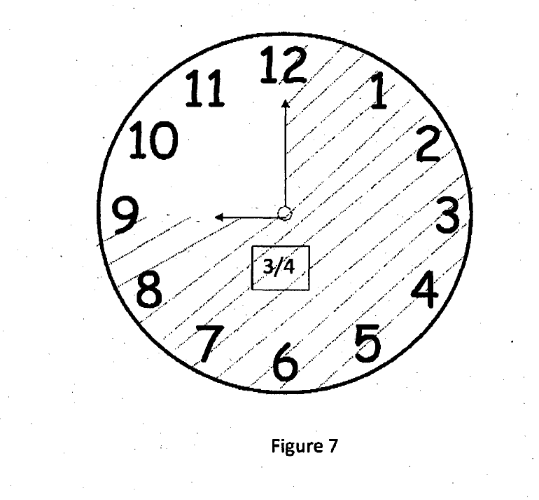

Illustration or equation etc is displayed on the face of the clock itself. The face of the clock can also change colour to aid in the teaching of fractions. For example, at 3 o'clock, the face of the clock can be shaded from 12 to 3 indicating to the user that 14 has been shaded. Then at 6 o'clock 16 the clock will be shaded and at 9 o'clock ¾ will be shaded providing the user with a physical illustration of what the fractions represent. Such an embodiment is presented in FIG. 7.

A further embodiment can include music, alarm to sound when a new equation appears on the digital display or the clock to include a voice to commentate the equation to the user. For example, at 2 pm when the equation is 12×2=24 the voice can dictate this to the user. Such a function can aid users with a visual impairment. To further this embodiment the user may be required to push a button before the answer is displayed. This will advance the learning of the user by continually testing their knowledge. It can also allow for the user to push a button to manually present the next equation without having to wait a further hour or so to receive the next equation. Further to this embodiment, adjustments can be made to the speed in which the learning elements are displayed. For example, a random new equation can be presented to the user, every hour, every minute or 30 seconds etc.

The face of the clock, the border around the clock, the hands, and the font of the numerical values including the digital layout, font and presentation of the secondary function can be adjusted according to the target age group of the user to make it more aesthetically pleasing, marketable and encouraging to learn. It can be altered in shape, size, and colour or through the addition of shapes or pictorial illustrations.

The clock itself can be of various shapes and sizes, the preferred embodiment being circular and of a size to be appropriately seen by users when attached to a wall. However, other alternatives can incorporate the invention as a wrist watch allowing the user to be tested in science, arithmetic etc while mobile. If presented in a wrist watch manner, a further embodiment can allow for the wrist watch to include a set of numerical keys hidden beneath the face of the clock. When an equation is therefore presented, the user will be required to physically input the numerical answer of the equation.

The clock itself can further be hung or be provided with a base to stand independently. The clock can further be part of computer, software displayed in digital or virtual form on a computer screen or in physical form being controlled by computer software.

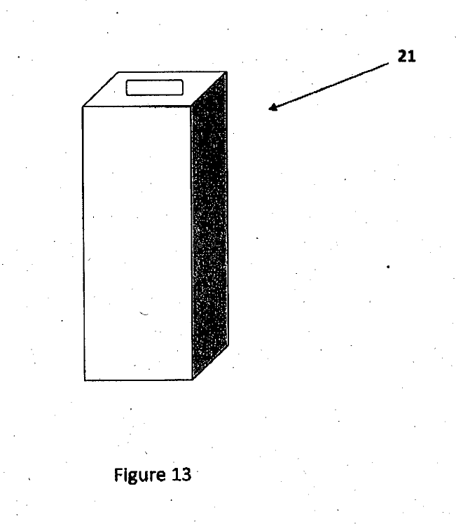

The apparatus for learning can further comprise of a microprocessor in which to allow the storage of memory. The apparatus for learning can comprise an internal memory or external memory.

Where the memory is internal, the device can allow for the connection to a computer via a cable or the like which to transfer information such as statistical data or listings of questions answered incorrectly. Where the memory device is external it can be in the form of a memory card 21 to be accessed on different telecommunication and electronic devices (see FIG. 13).

Further, the ability to interact with a computer will allow the user access to different programs which can be downloaded onto the learning apparatus. This will allow the single apparatus for learning to provide or be able to receive and display a number of different programs and learning elements as desired by the user.

An embodiment presented on the computer 30 will be presented on a computer screen as a virtual apparatus and learning system, herein referred to as virtual apparatus 40. By inputting the virtual apparatus onto a computer or other electronic device the system is able to manipulate its form to apply to the normal workings of the computer. For example in one embodiment, the apparatus and learning system has a recognition function which recognises the clock/time features of the computer and automatically sets the time on the virtual apparatus in accordance with the lime on the computer. The virtual apparatus then provides a periodically changing element according to the clock/time on the computer.

The virtual apparatus then forms a single unit with the computer using the mechanics, applications, input data and power source from the computer.

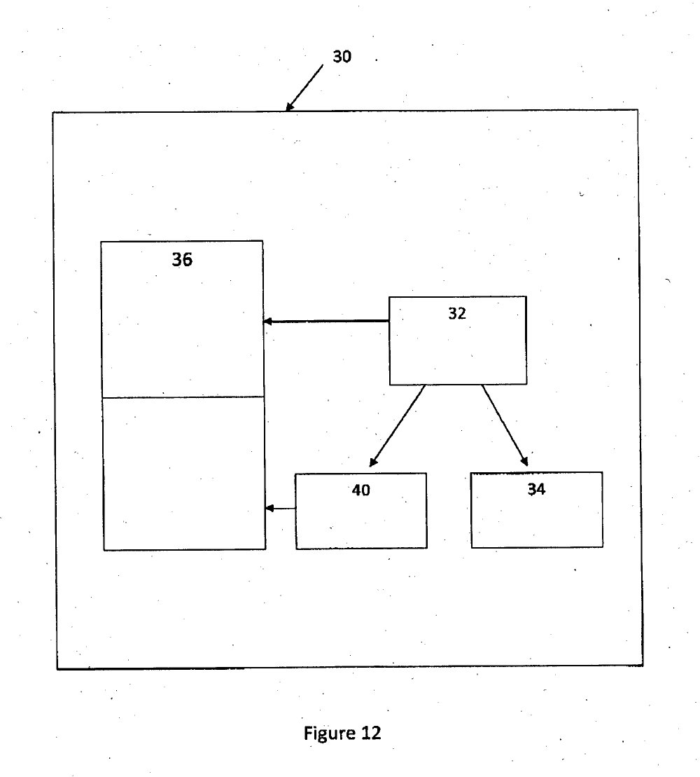

The embodiment presented in FIG. 12 illustrates the operational features of the computer 20 and the interaction with the virtual apparatus. The computer 30 is provide with a controller 32 which dictates the function and operational features of the computer 30. The computer 30 is provided with a clock time 34 which can be made visible to the user or hidden. The virtual apparatus 40 uses the controller 32 of the computer and is then presented to the user using a display 36. The controller is able to affect the operation of the virtual apparatus 40 using its dual control function between the time clock 34 and virtual apparatus 40 in which the virtual apparatus is dependent on the time clock 34.

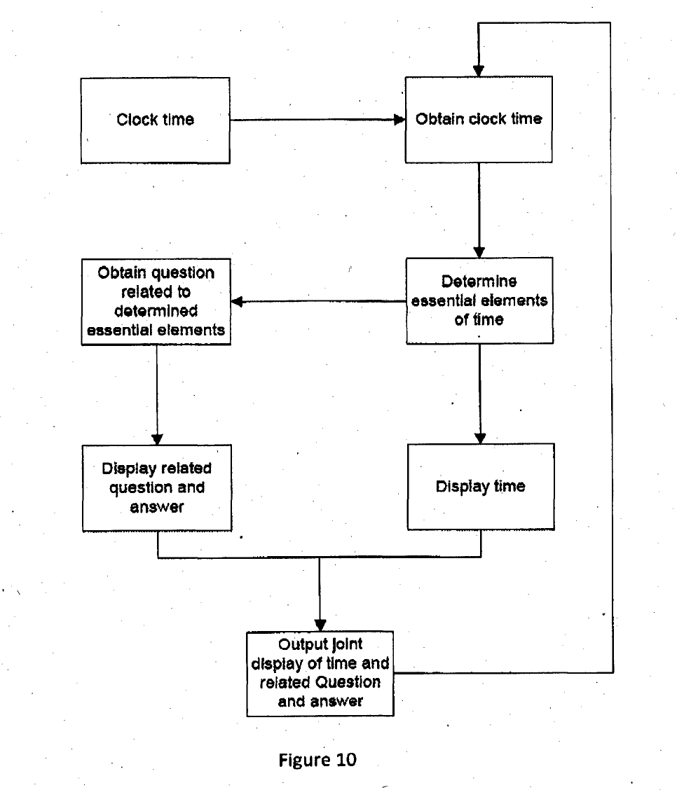

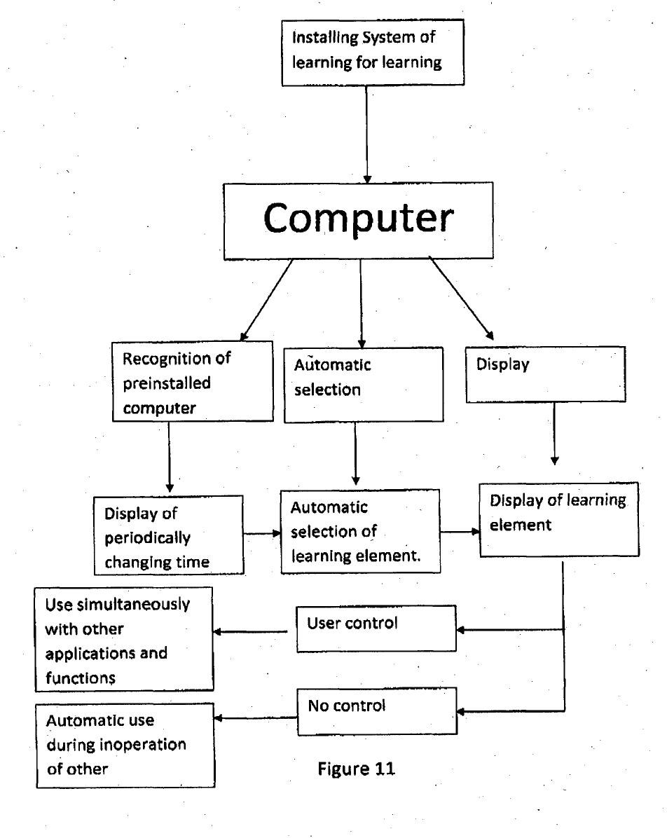

FIGS. 10 and 11 further illustrate the invention in virtual form. FIG. 10 provides a method of using a virtual apparatus for learning according. It provides a diagrammatic image identifying the relationship between the role and junction of the clock time 34. When using the virtual apparatus, the clock time is obtained from the controller of the compute which recognises and ascertains the essential elements of the clock time such as the positioning of the hands of the clock. In identifying the time the controller is able to manipulate this information into such a format recognisable and usable by the virtual apparatus. The virtual apparatus can then reflect the essential elements of the clock time to display, in the primary display function, the time and in the secondary display function, display the one or more learning elements or questions.

FIG. 12 further illustrates the operational features of the invention. A user is able to use the learning apparatus in virtual form by: uploading the virtual apparatus having a primary display function and secondary display function onto a computer; recognising the virtual apparatus by a controller of a computer; allowing the controller to determine the essential features of the time clock and the virtual apparatus; allowing the controller to correlate the virtual apparatus to the time clock; identifying a question to be answered or the learning element to be presented to a user; and display the virtual apparatus to a user to provide a system of learning wherein the essential features of the clock time are displayed on the primary display function and the question to be answered is displayed on the secondary display function.

Such a virtual apparatus provides an additional avenue of learning allowing the invention to be used in combination with other processes operating on the computer simultaneously. Alternatively, the virtual apparatus can be provided in the form of a screen saver. In such a form the user has limited control. Alternatively, the invention can be presented in a game like manner and can manipulate the frequency and type of questions.

The microprocessor will allow a user to design or formulate their programs as desired. Therefore, a teacher for example will be able to manipulate the programme in such a manner so as to provide an apparatus learning device according to the learning level of the students or the current topic to be taught to the students. Such a reprogrammable learning apparatus will allow such manipulations as the frequency or repetition of the questions, the nature and type of questions etc.

Alternatively, the memory device of the microprocessor can be formatted such that the apparatus for learning already provides for a number or combination of programs and the user can switch between the settings as desired. For example, a single apparatus for learning can comprise of a set of questions for the topics of history and geography and the user can select which they wish to proceed with or whether they would desire a combination of both.

As the apparatus for learning is an audio visual device which can be displayed in a wide variety of areas and forms, the apparatus for learning can be wirelessly attached to an external device, such as a computer, such that a user in front of the computer can further manipulate or change the programs as desired. Such a feature is convenient where the audio visual device is not in a convenient reachable location.

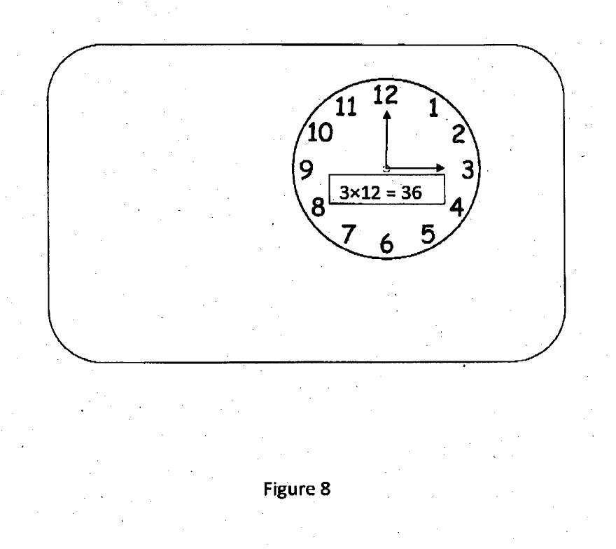

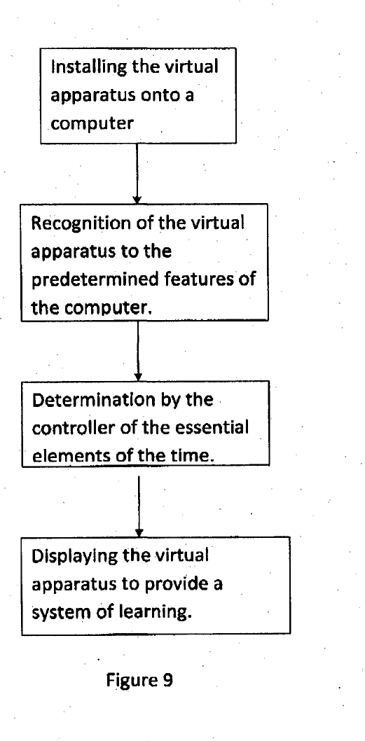

It is further envisaged that the clock can be provided as part of a computer or software system. For example, in one embodiment the invention appears as a screen saver. The invention can be operated using a computer having the clock displayed in digital form on a digital screen or as a digital photo as illustrated in FIG. 8.

While we have described herein a particular embodiment of an apparatus and means for learning, it is further envisaged that other embodiments of the invention could exhibit any number and combination of any one of the features previously described. However, it is to be understood that any variations and modifications which can be made without departing from the spirit of the invention are included within the scope thereof.

1. An apparatus for learning comprising:
a. a means having a primary display function with a periodic change;
b. and a secondary means for displaying a range of learning elements;
wherein one or more of the range of learning elements are displayed at any one time and are periodically changed in accordance with the periodic change of the primary means.

2. An apparatus for learning as claimed in claim 1 wherein the means having the primary function with a periodic change is a time display means.

3. An apparatus for learning as claimed in claim 1 wherein the periodic change is dependent on the time of day or dependent on the time between events.

4. (canceled)

5. An apparatus for learning as claimed in claim 1 wherein the means having a primary function with a periodic change is other than a time display means but which has a change of form based on time or event.

6. An apparatus for learning as claimed in claim 1 wherein the means having a primary function with a periodic change includes a signal indicating a patient is in attendance at a hospital or doctor's surgery and provides an educational tool for patients to assist in paediatric locations or for use with learning difficulty patients.

7. An apparatus for learning as claimed in claim 1 wherein the means having a primary function with a periodic change includes a signal indicating a student is in attendance at a school and provides an educational tool for students to assist in educational locations or for use with learning difficulty students.

8. An apparatus for learning as claimed in claim 1 wherein the display of a range of learning elements on the secondary means is directly related to the display of the means having a primary function with a periodic change thereby creating a relationship which increases the retentiveness of the knowledge by the viewer.

9. An apparatus for learning according to claim 1 wherein the primary function and the secondary means is controlled by an independent mechanism.

10. An apparatus for learning according to claim 9 wherein the independent mechanism is a computer.

11. An apparatus for learning according to claim 9 wherein the independent mechanism is a telecommunication device.

12. An apparatus for learning according to claim 9 wherein the independent mechanism is an internal microprocessor.

13. An apparatus for learning as claimed in claim 8 wherein:
a. the means having the primary display function with a periodic change is an analogue clock face with numbers 1-12 and two hands for showing minutes and hours;
b. the secondary means for displaying a range of learning elements is a display located on the clock face for showing an arithmetic equation;
c. the secondary means being directly related to the display of the means having a primary function are the numbers displayed in the arithmetic equation being determined by the position of the hands of the analogue clock face;
whereby each predetermined time is related to a different arithmetic equation and answer and displayed at that time.

14. (canceled)

15. An apparatus for learning as claimed in claim 13 wherein the analogue or digital clock face can be displayed on a computer screen with a related arithmetic equation located substantially adjacent or at least in a related position.

16. An apparatus for learning as claimed in claim 15 wherein the relationship between the time and the different arithmetic equation and answer provides a means of providing a randomised arithmetic problem based on the position of clock hands corresponding to a time of day.

17. An apparatus for learning as claimed in claim 13 or providing an apparatus comprising a first physical means for performing the primary function with a periodic change and includes a replaceable module for providing secondary means for displaying a range of learning elements whereby different ranges of learning elements can be inserted and operated dependent on different audience, different subject or just to effect a change.

18. An apparatus for learning as claimed in claim 13 wherein the apparatus is a known means such as a digital photo frame and the secondary means can alter its operation or its display to provide the system of learning instead of or in combination with the normal operation of the apparatus.

19. An apparatus for learning as claimed in claim 13 wherein the apparatus for learning comprises a multiple of selectable ranges of learning elements such that the different ranges of learning elements are selected and operated dependent on different audience, different subject or just to effect a change.

20.-21. (canceled)

22. An apparatus for learning wherein the apparatus is in the virtual form as a virtual apparatus with learning elements comprising:
a. a means having a primary function with periodic change;
b. and a secondary means for displaying a range of learning elements,
wherein one or more of the range of learning elements are displayed at any one time and are periodically changed in accordance with the periodic change of the primary means.

23. An apparatus for learning, having a method of using a virtual apparatus for learning according to claim 19 comprising:
a) installing the virtual apparatus onto a computer;
b) recognition of the virtual apparatus according to a controller providing predetermined features of the computer and the clock time;
c) determination by the controller of the essential elements of the clock times
d) displaying the essential elements of the clock time onto on the primary display function of the virtual apparatus; and
e) displaying the question on the secondary display function on the virtual apparatus to provide a system of learning.

24. A method of using a virtual apparatus for learning according to claim 23 wherein the question to be displayed on the secondary display function is related to the essential elements of the clock time displayed in the primary display function and/or the question to be displayed on the secondary display function appears in random.

25.-28. (canceled)

29. A method of using a virtual apparatus for learning according to claim 19 comprising the steps of:
a. installing the system of learning for learning;
b. recognition of a controller of preinstalled computer functions;
c. displaying periodically changing time elements;
d. selecting at least one learning element amongst a plurality of learning elements; and
e. displaying at least one learning element simultaneously with other applications and functions of the controller.

30. (canceled)

31. A method of using a virtual apparatus for learning according to claim 19 comprising the steps of:
a. determination of the essential features of a clock time by a controller;
b. correlation by the controller of the clock time and the primary display function of the virtual display;
c. identifying a question to be presented to user according to the determined correlation by the controller;
d. displaying the essential features of the clock time on the primary display function of the virtual apparatus; and
e. displaying at least one learning element on a secondary display function on the virtual apparatus.

32.-35. (canceled)
